(19) United States
(12) Patent Application Publication
(10) Pub. No.: US 2025/0008045 A1
(43) Pub. Date: Jan. 2, 2025

(54) IMAGE READING APPARATUS

(71) Applicant: FUJIFILM Business Innovation Corp., Tokyo (JP)

(72) Inventors: Takashi ODA, Kanagawa (JP); Norikazu SAKAI, Kanagawa (JP); Kazunori SATO, Kanagawa (JP); Takaharu SATO, Kanagawa (JP); Yuki HANADA, Kanagawa (JP)

(73) Assignee: FUJIFILM Business Innovation Corp., Tokyo (JP)

(21) Appl. No.: 18/523,891

(22) Filed: Nov. 30, 2023

(30) Foreign Application Priority Data
Jun. 30, 2023 (JP) 2023-107807

(51) Int. Cl. H04N 1/409; H04N 1/00; H04N 1/028

(52) U.S. Cl. CPC H04N 1/4097; H04N 1/00909; H04N 1/028

(57) ABSTRACT

An image reading apparatus includes: a shading roller that has a columnar shape extending in a longitudinal direction and is rotatable about a rotation axis extending in the longitudinal direction, the shading roller including, on an outer peripheral surface, a first white reference arc surface which is white, has an arc-shaped cross section in a lateral direction, and extends in the longitudinal direction, and a groove portion which is located at a position preceding the first white reference arc surface in a rotation direction of the shading roller and extends in the longitudinal direction; an image sensor array that is provided above the shading roller to oppose the shading roller across a transport path of a document, and includes a plurality of image sensors arranged in a main scanning direction and receiving reflected light of light emitted from a light source toward the document or the shading roller; and a processor, wherein the processor acquires shading data based on first arc surface read data indicating pixel values output from the image sensors, respectively, and obtained as the image sensor array receives the reflected light from the first white reference arc surface, corrects document read data, obtained as the image sensor array receives the reflected light from the document, based on the shading data to acquire corrected document read data, and forms image data corresponding to the document based on the corrected document read data.

### CROSS-REFERENCE TO RELATED APPLICATIONS

This application is based on and claims priority under 35 USC 119 from Japanese Patent Application No. 2023-107807 filed Jun. 30, 2023.

### BACKGROUND

### (i) Technical Field

The present invention relates to an image reading apparatus.

### (ii) Related Art

Conventionally, an image reading apparatus that reads a surface of a document by a contact image sensor (CIS) while transporting the document has been proposed. The CIS includes an image sensor array including a plurality of image sensors arranged in a main scanning direction. In addition, the image reading apparatus has a shading correction function of correcting unevenness in the amount of light of a light source in the main scanning direction, unevenness in sensitivity of each of the image sensors, or the like in image data obtained by scanning in some cases.

The image reading apparatus having the shading correction function generally includes a shading roller opposing the CIS across a document transport path. The shading roller is a member whose outer peripheral surface is provided with a reference surface for obtaining shading data, which is correction data for shading correction. The image sensor array of the CIS receives reflected light from the outer peripheral surface of the shading roller, whereby shading data indicating pixel values output from the respective image sensors is acquired.

Here, the amount of light received by the image sensor varies depending on a distance between the image sensor and the outer peripheral surface of the shading roller or the document. Specifically, the amount of light received by the image sensor decreases in proportion to the square of the distance. Therefore, in order to obtain appropriate shading data, it is ideal to obtain shading data by setting the distance from the image sensor to the document and the distance from the image sensor to the outer peripheral surface of the shading roller to be the same.

In this regard, conventionally, a technique has been proposed in which a distance from an image sensor to a document and a distance from the image sensor to an outer peripheral surface of a shading roller are set to be the same to obtain shading data and a shading roller is prevented from coming into contact with the document when the document is transported.

For example, JP2011-030174A and JP2014-003385A disclose a shading roller having a first portion in which a distance from a rotation center to an outer peripheral surface is substantially equal and a second portion in which a distance from the rotation center to an outer peripheral surface is shorter than that of the first portion. In JP2011-030174A, the outer peripheral surface of the first portion is set to oppose a CIS such that a distance from the image sensor to the outer peripheral surface of the shading roller is the same when shading data is to be acquired, and the outer peripheral surface of the second portion is set to oppose to the CIS such that the shading roller is retracted from a document transport path when a document is transported.

Meanwhile, it is conceivable that floating debris enters between the image sensor and the shading roller during acquisition of shading data. The floating debris means debris which is not fixed to a member such as the outer peripheral surface of the shading roller. If the floating debris enters between the image sensor and the shading roller during acquisition of shading data, it is not possible to acquire appropriate shading data due to an influence of the floating debris.

### SUMMARY

Aspects of non-limiting embodiments of the present disclosure relate to an image reading apparatus that reduces an influence of floating debris that may enter between an image sensor and a shading roller during acquisition of shading data as compared with a case where a groove is not provided in an arc surface that is an outer peripheral surface of the shading roller.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image reading apparatus comprising:
a shading roller that has a columnar shape extending in a longitudinal direction and is rotatable about a rotation axis extending in the longitudinal direction, the shading roller including, on an outer peripheral surface, a first white reference arc surface which is white, has an arc-shaped cross section in a lateral direction, and extends in the longitudinal direction, and a groove portion which is located at a position preceding the first white reference arc surface in a rotation direction of the shading roller and extends in the longitudinal direction;
an image sensor array that is provided above the shading roller to oppose the shading roller across a transport path of a document, and includes a plurality of image sensors arranged in a main scanning direction and receiving reflected light of light emitted from a light source toward the document or the shading roller; and
a processor,
wherein the processor
acquires shading data based on first arc surface read data indicating pixel values output from the image sensors, respectively, and obtained as the image sensor array receives the reflected light from the first white reference arc surface,
corrects document read data, obtained as the image sensor array receives the reflected light from the document, based on the shading data to acquire corrected document read data, and
forms image data corresponding to the document based on the corrected document read data.

### BRIEF DESCRIPTION OF THE DRAWINGS

FIG. 1 is a schematic diagram illustrating a configuration of an image reading apparatus according to an embodiment.

FIG. 2 is a lateral cross-sectional view of a first shading roller according to the embodiment.

FIG. 3 is a perspective view of the first shading roller according to the embodiment.

FIG. 4 is a lateral cross-sectional view of a second shading roller according to the embodiment.

FIG. 5 is a schematic diagram of a configuration of a processor.

FIG. 6 is a view illustrating movements of floating debris accompanying rotation of the shading roller.

FIG. 7 is a view illustrating an example of shading data.

FIG. 8 is a view illustrating an example of one side arc surface read data.

FIG. 9 is a view illustrating an example of another side arc surface read data.

FIG. 10 is a schematic diagram illustrating a configuration of an image reading apparatus according to a modified embodiment.

### DETAILED DESCRIPTION

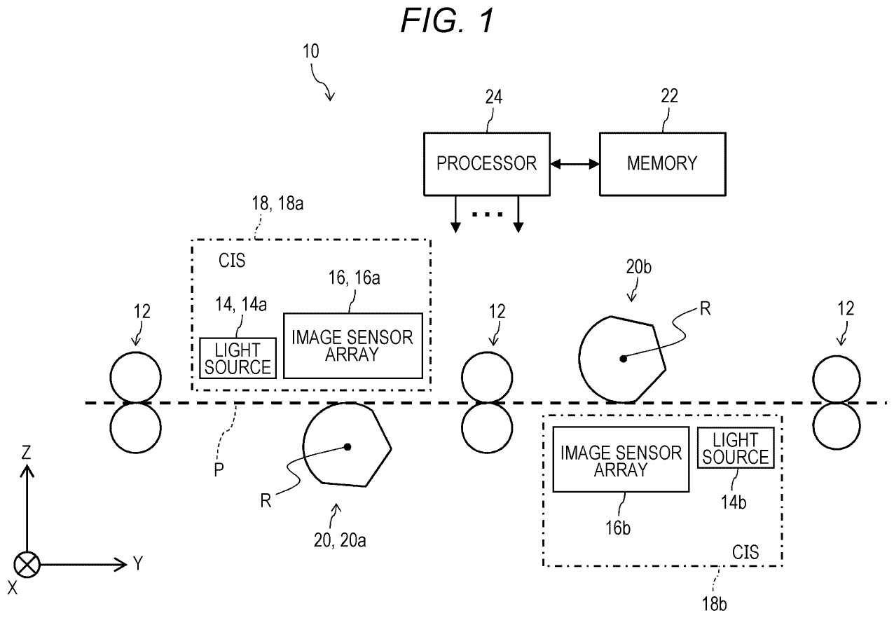

FIG. 1 is a schematic diagram illustrating a configuration of an image reading apparatus 10 according to an embodiment. In each drawing of the present specification, an X-axis direction indicates a main scanning direction, a Y-axis direction indicates a sub scanning direction, and a Z-axis direction indicates a height direction. The image reading apparatus 10 is an apparatus that optically reads (in other words, performs a scanning process on) a document, which is a medium such as paper, and forms image data representing the document. The image reading apparatus 10 is, for example, a scanner or a multi-function peripheral having a scanning function. As illustrated in FIG. 1, the image reading apparatus 10 includes a document feed roller 12, a CIS 18 including a light source 14 and an image sensor array 16, a shading roller 20, a memory 22, and a processor 24.

The document feed roller 12 transports a medium along a transport path P for the medium. In the example of FIG. 1, a plurality of pairs of the document feed rollers 12 are provided, and each pair of the document feed rollers 12 rotates with the medium being nipped in a nip portion thereof, thereby transporting the medium from the left side to the right side.

The light source 14 emits light toward the document or the shading roller 20 for the scanning process. A plurality of the light sources 14 may be provided along the X-axis.

The image sensor array 16 includes a plurality of (for example, ten odd) image sensors arranged in the X-axis direction. Each of the image sensors receives reflected light of the light emitted from the light source 14 toward the document or the shading roller 20, and outputs a pixel value based on the received reflected light. The image sensor array 16 is provided to oppose the shading roller 20 across the transport path P.

The shading roller 20 is a columnar component extending substantially in a longitudinal direction along the image sensor array 16. The shading roller 20 is provided so as to oppose the image sensor array 16 across the transport path P.

A white reference surface configured to obtain shading data for shading correction is provided on an outer peripheral surface of the shading roller 20. The shading correction is correction for suppressing a variation in the pixel value output by the image sensor array 16 caused by a difference in the amount of light pf the light source 14 (including a difference between the light sources 14 and a difference due to a temporal change in the same light source 14), a difference in sensitivity of the image sensor (including a difference between the image sensors and a difference due to a temporal change in the same image sensor), or the like. The shading data is formed by the pixel value output by the image sensor array 16 receiving the reflected light of the light from the light source 14 reflected from the white reference surface of the shading roller 20.

As illustrated in FIG. 1, the image reading apparatus 10 according to the embodiment has two combinations of the CISs 18 and the shading rollers 20. That is, the image reading apparatus 10 includes: a CIS 18a including an image sensor array 16a which receives reflected light from a first surface (for example, a back surface) of the document or a shading roller 20a; the shading roller 20a for generating shading data of the CIS 18a; a CIS 18b including an image sensor array 16b as a subsequent image sensor array that receives reflected light from a second surface (for example, a front surface) of the document or the shading roller 20b; and the shading roller 20b as a subsequent shading roller for generating shading data of the CIS 18b.

The combination of the CIS 18b and the shading roller 20b is provided on the downstream side of the transport path P with respect to the combination of the CIS 18a and the shading roller 20a. That is, the image sensor array 16b is provided on the downstream side of the transport path P with respect to the image sensor array 16a, and the shading roller 20b is provided on the downstream side of the transport path P with respect to the shading roller 20a.

In the embodiment, the CIS 18a and the CIS 18b have the same structure, and the shading roller 20a and the shading roller 20b also have substantially the same structure as will be described below.

There is a case where foreign matter (for example, paper dust) is generated from a document when the document passes between the CIS 18 and the shading roller 20. It can be said that the foreign matter from the document is likely to be generated more on the upstream side of the transport path P. If such foreign matter adheres to an opposing surface of the CIS 18 opposing the transport path P (for example, a transparent glass plate covering the image sensor array 16a), the foreign matter affects the pixel value output from the image sensor array 16. Therefore, the CIS 18a on the upstream side of the transport path P (that is, the image sensor array 16a) is provided above the transport path P in the embodiment. In other words, the shading roller 20a on the upstream side of the transport path P is provided below the CIS 18a (that is, the image sensor array 16a) and the transport path P. Thus, the foreign matter from the document falls downward by the action of gravity so that the foreign matter is prevented from adhering to the opposing surface the CIS 18a. When the shading roller 20a is located below the transport path P, a possibility that the foreign matter from the document falls on the shading roller 20a increases so that a possibility that an influence of the foreign matter appear in shading data increases. In the embodiment, however, it is possible to reduce the influence of the foreign matter appearing in the shading data acquired by using the shading roller 20a as will be described later.

In the embodiment, the document is not inverted during the transport along the transport path P, and the CIS 18a is located above the shading roller 20a (in other words, the shading roller 20a is located below the CIS 18a), and thus, the CIS 18b that reads the surface of the document different from that in the CIS 18a is necessarily located below the shading roller 20b (in other words, the shading roller 20b is located above the CIS 18a).

Note that the image reading apparatus 10 may include only one combination of the CIS 18 and the shading roller 20. Also in this case, the shading roller 20 may be located below the CIS 18.

In the present specification, a light source 14a and a light source 14b are described simply as the light source 14 when not particularly distinguished, the image sensor array 16a and the image sensor array 16b are described simply as the image sensor array 16 when not particularly distinguished, the CIS 18a and the CIS 18b are described simply as the CIS 18 when not particularly distinguished, and the shading roller 20a and the shading roller 20b are described simply as the shading roller 20 when not particularly distinguished.

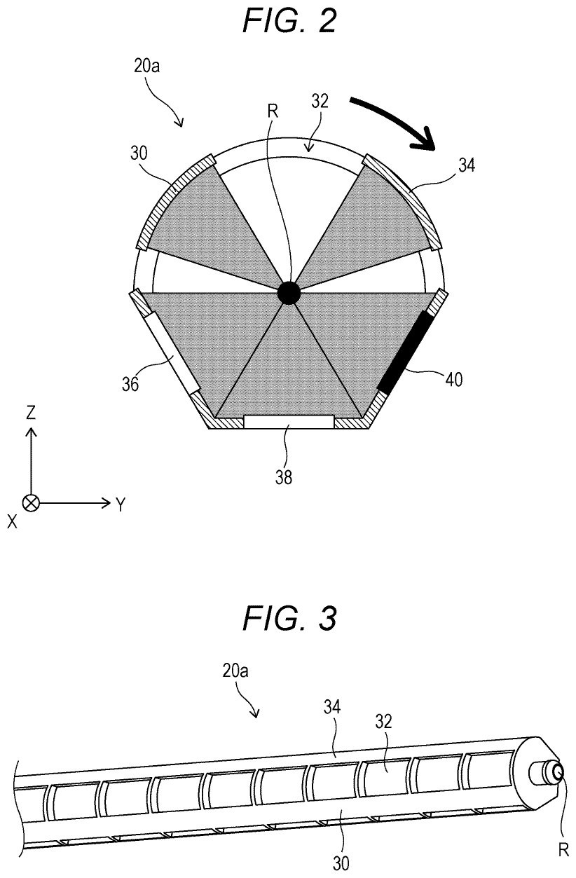

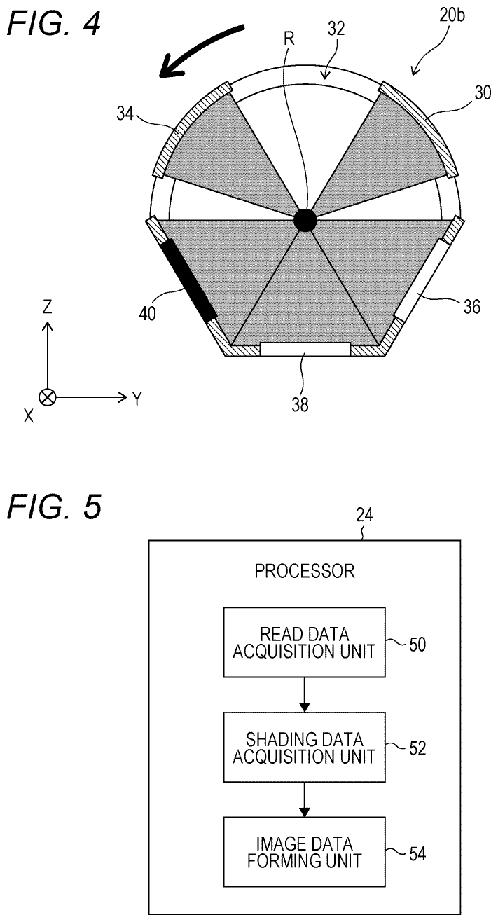

FIG. 2 is a conceptual view illustrating a schematic shape of a cross section of the shading roller 20a in a lateral direction. FIG. 3 is a perspective view of the shading roller 20a according to the embodiment. FIG. 4 is a conceptual view illustrating a schematic shape of a cross section of the shading roller 20b in the lateral direction. The shading roller 20 is rotatable about a rotation axis R extending in the longitudinal direction. The outer peripheral surface of the shading roller 20 has various surfaces as will be described later, and the shading roller 20 is rotatable about the rotation axis R so that a surface opposing the image sensor array 16 (or the light source 14) can be changed.

As illustrated in FIGS. 2 and 4, the shading roller 20 includes, on the outer peripheral surface, a first white reference arc surface 30 that is white, has an arc-shaped cross section in the lateral direction, and extends in the longitudinal direction. In the embodiment, a cross-sectional shape of the first white reference arc surface 30 is an arc shape centered on the rotation axis R.

The shading roller 20 has, on the outer peripheral surface, a groove portion 32 that is located at a position preceding the first white reference arc surface 30 in the rotation direction of the shading roller 20 and extends in the longitudinal direction. The groove portion 32 is a portion whose outer peripheral surface (in other words, a bottom surface of the groove portion 32) is located on a side closer to the rotation axis R than the first white reference arc surface 30. That is, a diameter from the rotation axis R to the bottom surface of the groove portion 32 is smaller than a diameter from the rotation axis R to the first white reference arc surface 30.

In the embodiment, the shading roller 20 has, on the outer peripheral surface, a second white reference arc surface 34 that is located at a position preceding the groove portion 32 in the rotation direction of the shading roller 20, is white, has an arc-shaped cross section in the lateral direction, and extends in the longitudinal direction. A cross-sectional shape of the second white reference arc surface 34 may also be an arc shape centered on the rotation axis R. That is, the diameter from the rotation axis R to the first white reference arc surface 30 and a diameter from the rotation axis R to the second white reference arc surface 34 are the same, and both the diameters are longer than the diameter from the rotation axis R to the bottom surface of the groove portion 32.

In addition, the outer peripheral surface of the shading roller 20 may have a plurality of flat surfaces in addition to the first white reference arc surface 30 and the second white reference arc surface 34. For example, as illustrated in FIG. 2 or 4, the shading roller 20 has three flat surfaces in addition to the first white reference arc surface 30 and the second white reference arc surface 34 on the outer peripheral surface in the embodiment. A first flat surface 36 and a second flat surface 38 are used as a contamination surface. There is a case where foreign matter is generated from a medium and adhere to the shading roller 20 when the medium passes between the image sensor array 16 and the shading roller 20. In order to prevent such foreign matter from adhering to the first white reference arc surface 30 and the second white reference arc surface 34, the first flat surface 36 or the second flat surface 38 is set to oppose the image sensor array 16 when the medium passes between the image sensor array 16 and the shading roller 20. A black flat surface 40 is black, and is used to improve the position detection accuracy of the document transported along the transport path P by setting the black flat surface 40 to oppose the image sensor array 16.

As illustrated in FIG. 2 or 4, the second white reference arc surface 34, the groove portion 32, the first white reference arc surface 30, the first flat surface 36, the second flat surface 38, and the black flat surface 40 are arranged in this order on the outer peripheral surface of the shading roller 20 toward a direction opposite to the rotation direction of the shading roller 20 in the embodiment. That is, as the shading roller 20 rotates, the surface opposing the image sensor array 16 is switched in the above-described order.

The shading roller 20a rotates clockwise as indicated by an arrow in FIG. 2 when viewed from the negative side in the X-axis direction. On the other hand, the shading roller 20b rotates counterclockwise as indicated by an arrow in FIG. 4 when viewed from the negative side in the X-axis direction. Therefore, when viewed from the negative side in the X-axis direction, the arrangement order of the second white reference arc surface 34, the groove portion 32, the first white reference arc surface 30, the first flat surface 36, the second flat surface 38, and the black flat surface 40 along the circumferential direction is reversed between the shading roller 20a and the shading roller 20b.

In the embodiment, a distance from the rotation axis R to the first white reference arc surface 30 and a distance from the rotation axis R to the second white reference arc surface 34 are the same as a distance from the rotation axis R to the transport path P (see FIG. 1). As described above, the amount of light received by each of the image sensors included in the image sensor array 16 varies depending on a distance between the image sensor and the outer peripheral surface of the shading roller 20 or the document, and it is possible to obtain shading data by setting the distance from each of the image sensors to the document to be the same as the distance from each of the image sensors to the outer peripheral surface of the shading roller 20.

In contrast, distances from the rotation axis R to the respective flat surfaces of the first flat surface 36, the second flat surface 38, and the black flat surface 40 are smaller than the distance from the rotation axis R to the transport path P. Thus, if any of the first flat surface 36, the second flat surface 38, and the black flat surface 40 is set to oppose the image sensor array 16, interference between the medium transported along the transport path P and the shading roller 20 can be suppressed.

Returning to FIG. 1, the memory 22 includes, for example, a hard disk drive (HDD), a solid state drive (SSD), an embedded multi media card (eMMC), a read only memory (ROM), or a random access memory (RAM). The memory 22 stores an image reading program for operation of each unit of the image reading apparatus 10.

FIG. 5 is a schematic diagram of a configuration of the processor 24. The processor 24 exhibits functions as a read data acquisition unit 50, a shading data acquisition unit 52, and an image data forming unit 54 by the image reading program stored in the memory 22.

The read data acquisition unit 50 rotates the shading roller 20 such that the first white reference arc surface 30 of the shading roller 20 opposes the image sensor array 16. In this state, the read data acquisition unit 50 acquires data indicating pixel values output from the respective image sensor included in the image sensor array 16, the pixel values being obtained by the image sensor array 16 receiving reflected light from the first white reference arc surface 30 of light emitted from the light source 14 to the first white reference arc surface 30. In this specification, this data is referred to as first arc surface read data.

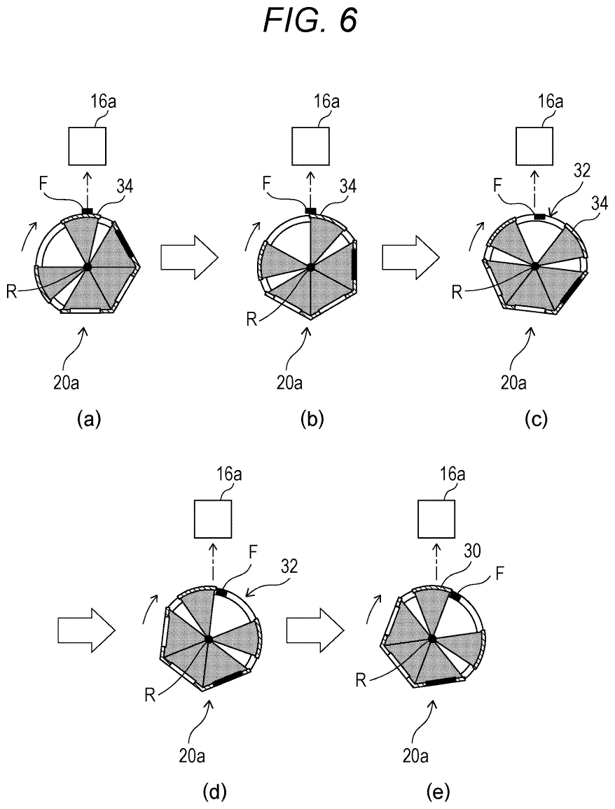

In the embodiment, the groove portion 32 is provided at the position preceding the first white reference arc surface 30 in the rotation direction of the shading roller 20a on an outer peripheral surface of the shading roller 20a provided below the transport path P, and thus, a possibility that the first arc surface read data is affected by floating debris is reduced. This will be described with reference to FIG. 6.

For example, considered is a case where the initial state of the shading roller 20a (here, the state means a rotation angle) is a state where the second white reference arc surface 34 opposes the image sensor array 16a as illustrated in a part (a) of FIG. 6. Here, it is assumed that floating debris F is placed on the second white reference arc surface 34. If the image sensor array 16a receives reflected light from the second white reference arc surface 34 in this state, a pixel value output by any of the image sensors included in the image sensor array 16a is affected by the floating debris F. That is, when the image sensor array 16a acquires shading data by receiving the reflected light from the second white reference arc surface 34 in this state, the shading data is affected by the floating debris F.

As illustrated in a part (b) of FIG. 6, the read data acquisition unit 50 rotates the shading roller 20a about the rotation axis R. Since the floating debris F is not foreign matter adhering to the second white reference arc surface 34, the floating debris F slides on the second white reference arc surface 34 and remains at a corresponding place (in the example of a part (b) of FIG. 6, at a position just opposing the image sensor array 16a) even when the shading roller 20a rotates. In the state illustrated in a part (b) of FIG. 6, the floating debris F is located at a rear end of the second white reference arc surface 34 in the rotation direction.

When the shading roller 20a further rotates from the state illustrated in a part (b) of FIG. 6, the floating debris F falls from the second white reference arc surface 34 to the groove portion 32 by the action of gravity as illustrated in a part (c) of FIG. 6. However, even after falling into the groove portion 32, the floating debris F slides on the bottom surface of the groove portion 32 as the shading roller 20a rates, and remains at the corresponding place (at the position opposing the image sensor array 16 even in the example of a part (c) of FIG. 6) in some cases.

When the shading roller 20a further rotates from the state illustrated in a part (c) of FIG. 6, the floating debris F eventually abuts on a sidewall of the groove portion 32 on the rear side in the rotation direction as illustrated in a part (d) of FIG. 6. When the shading roller 20a rotates after the floating debris F abuts on the sidewall of the groove portion 32, the floating debris F is pushed by the sidewall and moves in the rotation direction.

Since the sidewall of the groove portion 32 pushes the floating debris, the floating debris F is no more at the position opposing the image sensor array 16a when the shading roller 16a rotates to a position where the first white reference arc surface 30 opposes the image sensor array 20a as illustrated in a part (e) of FIG. 6. Therefore, an influence of the floating debris F can be reduced in the first arc surface read data acquired by the read data acquisition unit 50. If the shading roller 20a further rotates from the state illustrated in a part (e) of FIG. 6, the floating debris F is detached from the surfaces of the shading roller 20a by the action of gravity, and falls below the shading roller 20a.

The read data acquisition unit 50 may cause each of the image sensors to repeatedly output pixel values corresponding to the reflected light from the first white reference arc surface 30 a plurality of times while rotating the shading roller 20 so as to acquire a plurality of the pixel values in time series for each of the image sensors. Based on the plurality of pixel values in time series acquired by each of the image sensors, the read data acquisition unit 50 may calculate a representative pixel value (for example, an average pixel value) of the image sensor to set the representative pixel value of each of the image sensors as the first arc surface read data. Thus, in the first arc surface read data, it is possible to reduce the influence of the foreign matter on some pixel values among a plurality of pixel values in time series related to a certain image sensor and noise suddenly output by the image sensor.

Since a cross-sectional shape of the first white reference arc surface 30 is a semicircular shape centered on the rotation axis R in the embodiment, a distance between the image sensor and the first white reference arc surface 30 does not vary even when the shading roller 20 is rotated.

The shading data acquisition unit 52 obtains shading data based on the first arc surface read data obtained by the read data acquisition unit 50. In the embodiment, the shading data acquisition unit 52 can use the first arc surface read data directly as the shading data.

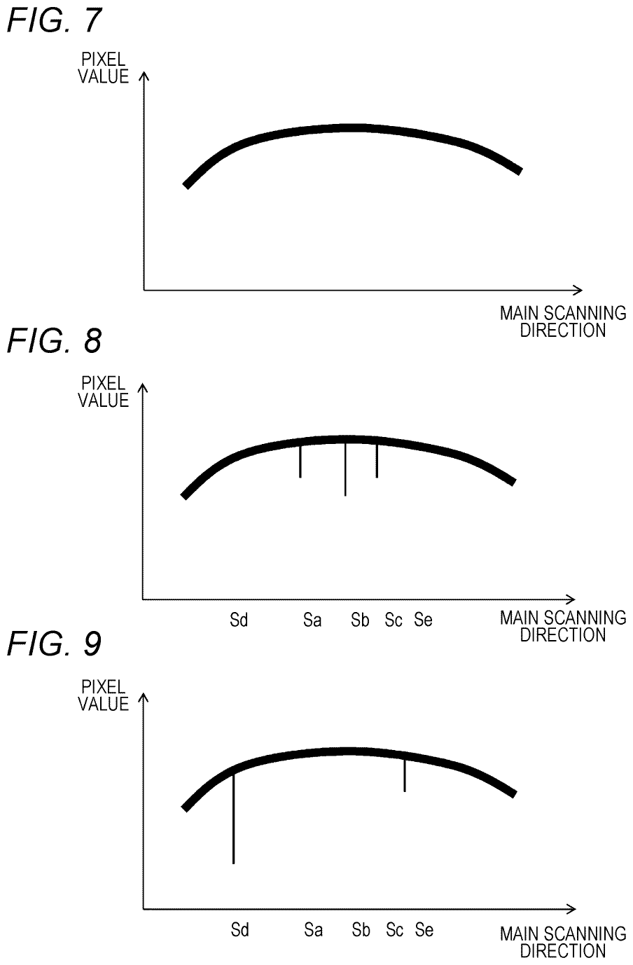

FIG. 7 illustrates an example of the shading data. A horizontal axis represents (the image sensors arranged in) the X-axis direction, that is, the main scanning direction, and a vertical axis represents a pixel value output from each of the image sensors in FIG. 7 (and the same applies to FIGS. 8 and 9 to be described later). Note that the pixel value is, for example, a brightness value. There is a case where high-frequency noise caused by the image sensor is superimposed on the shading data. In FIG. 7, a state where such high-frequency noise is superimposed is represented by the thick line. The high-frequency noise caused by the image sensor is similarly superimposed on image data obtained by the image sensor array 16 actually reading the document. Therefore, since the high-frequency noise is superimposed on the shading data, more appropriate shading correction may be performed.

The image data forming unit 54 causes the light source 14 to irradiate the document transported along the transport path P with light, and acquires document read data obtained by the image sensor array 16 receiving reflected light from the document.

In addition, the image data forming unit 54 corrects the acquired document read data based on the shading data (see FIG. 7) acquired by the shading data acquisition unit 52, and acquires corrected document read data. Since a conventional method may be employed as a method for correcting the document read data based on the shading data, a detailed description thereof is omitted here. For example, in the shading data of FIG. 7, since the pixel values are lower at both end portions as compared with the central portion in the main scanning direction, the image data forming unit 54 corrects the document read data based on the shading data so as to raise pixel values in both the end portions as compared with the central portion in the main scanning direction.

Further, the image data forming unit 54 forms image data corresponding to the document based on the corrected document read data. The formed image data is stored in the memory 22 or is transmitted to an apparatus (for example, a personal computer or a server) outside the image reading apparatus 10 by a communication unit (not illustrated) included in the image reading apparatus 10.

As described above, the influence of the floating debris in the shading data based on the first arc surface read data can be reduced according to the embodiment. However, it is difficult to completely remove the influence of the foreign matter in the first arc surface read data in some cases. For example, there are a case where the floating debris accidentally enters between the first white reference arc surface 30 and the image sensor array 16 at the timing when the image sensor array 16 receives the reflected light from the first white reference arc surface 30 and a case where debris (fixed debris) or dirt fixed onto the first white reference arc surface 30 exists. In such cases, when the shading data is acquired based on only the first arc surface read data, the influence of the foreign matter also appears in the shading data.

Therefore, in order to reduce the influence of the foreign matter on the shading data, it is preferable for the shading data acquisition unit 52 to acquire the shading data based on both the first arc surface read data and second arc surface read data that indicates pixel values output by the respective image sensors and is obtained by the image sensor array 16 receiving reflected light from the second white reference arc surface 34.

Specifically, first, the read data acquisition unit 50 rotates the shading roller 20 such that the second white reference arc surface 34 of the shading roller 20 opposes the image sensor array 16. In this state, the read data acquisition unit 50 acquires data indicating pixel values output from the respective image sensor included in the image sensor array 16, the pixel values being obtained by the image sensor array 16 receiving reflected light from the second white reference arc surface 34 of light emitted from the light source 14 to the second white reference arc surface 34. In this specification, this data is referred to as second arc surface read data.

Similarly to the case of acquiring the first arc surface read data, the read data acquisition unit 50 may cause each of the image sensors to repeatedly output pixel values corresponding to the reflected light from the second white reference arc surface 34 a plurality of times while rotating the shading roller 20 so as to acquire a plurality of the pixel values in time series for each of the image sensors. Then, a representative pixel value (for example, an average pixel value) of the image sensor may be calculated based on the plurality of pixel values in time series acquired by each of the image sensors to set the representative pixel value of each of the image sensors as the second arc surface read data.

Next, the read data acquisition unit 50 acquires the first arc surface read data as described above.

In the present specification, one of the first arc surface read data and the second arc surface read data is referred to as one side arc surface read data, and the other of the first arc surface read data and the second arc surface read data is referred to as another side arc surface read data.

FIG. 8 illustrates an example of the second arc surface read data as the one side arc surface read data, and FIG. 9 illustrates an example of the first arc surface read data as the other side arc surface read data. In FIG. 8 or 9, a protruding portion protruding in the up-down direction is the influence of the foreign matter. In particular, regarding the shading roller 20a, the influence of the floating debris on the first arc surface read data is sometimes reduced by an effect of the groove portion 32 as described above, and the second arc surface read data is sometimes more likely to be affected by foreign matter than the first arc surface read data.

The shading data acquisition unit 52 analyzes the one side arc surface read data to identify an abnormal pixel value that is a pixel value affected by the foreign matter existing between the image sensor array and the first white reference arc surface 30 (in a case where the one side arc surface read data is the first arc surface read data) or the second white reference arc surface 34 (in a case where the one side arc surface read data is the second arc surface read data) when the one side arc surface read data is acquired. The abnormal pixel value can be identified by a known method. For example, the shading data acquisition unit 52 can identify the abnormal pixel value by subtracting, from the one side arc surface read data, filtered read data obtained by applying a low-pass filter to the one side arc surface read data. In the example of FIG. 8, a pixel value of an image sensor Sa, a pixel value of an image sensor Sb, and a pixel value of an image sensor Sc are identified as abnormal pixel values.

Then, the shading data acquisition unit 52 replaces the identified abnormal pixel value in the one side arc surface read data with a pixel value of the image sensor corresponding to the abnormal pixel value included in the other side arc surface read data, thereby acquiring the shading data. In the examples of FIGS. 8 and 9, the shading data acquisition unit 52 replaces the pixel value of the image sensor Sa, the pixel value of the image sensor Sb, and the pixel value of the image sensor Sc in the one side arc surface read data illustrated in FIG. 8 with a pixel value of the image sensor Sa, a pixel value of the image sensor Sb, and a pixel value of the image sensor Sc in the other side arc surface read data, respectively. Thus, the shading data (see FIG. 7) in which the influence of the foreign matter is reduced is acquired.

The one side arc surface read data may be first arc surface read data. In this case, the shading data acquisition unit 52 identifies an abnormal pixel value in the first arc surface read data (see FIG. 9) which is the one side arc surface read data. In the example of FIG. 9, a pixel value of an image sensor Sd and a pixel value of an image sensor Se are identified as abnormal pixel values. Then, the shading data acquisition unit 52 replaces the pixel value of the image sensor Sd and the pixel value of the image sensor Se in the first arc surface read data, which is the one side arc surface read data illustrated in FIG. 9, with a pixel value of the image sensor Sd and a pixel value of the image sensor Se in the second arc surface read data which is the other side arc surface read data, respectively. Also in this manner, the shading data (see FIG. 7) in which the influence of the foreign matter is reduced is similarly acquired.

In the embodiment, the shading data acquisition unit 52 sets the second arc surface read data, which is more likely to be affected by foreign matter, as the one side arc surface read data. That is, the shading data acquisition unit 52 analyzes the second arc surface read data to identify an abnormal pixel value and replaces the identified abnormal pixel value with a pixel value of the image sensor corresponding to the abnormal pixel value included in the first arc surface read data, thereby acquiring the shading data.

As described above, the shading data acquisition unit 52 identifies the abnormal pixel value in the one side arc surface read data. The abnormal pixel value may also be generated by foreign matter, dirt, or the like adhering to a surface (in this case, the second white reference arc surface 34) corresponding to the one side arc surface read data. Therefore, when the one side arc surface read data is set as the second arc surface read data, identifying the abnormal pixel value from the one side arc surface read data is the same as detecting the foreign matter or dirt adhering to the second white reference arc surface 34.

Here, in a case where a certain amount of foreign matter or dirt adheres to the outer peripheral surface of the shading roller 20, it is desirable to perform maintenance on the shading roller 20. In this regard, in the embodiment, the second arc surface read data, which is more likely to be affected by foreign matter, is set as the one side arc surface read data so as to detect the foreign matter or dirt adhering to the second white reference arc surface 34 which is more likely to be affected by foreign matter or dirt, whereby a user (including an administrator) of the image reading apparatus 10 can be notified of the need for the maintenance of the shading roller 20 at an earlier stage.

As described above, the shading roller 20 is set such that the first white reference arc surface 30 or the second white reference arc surface 34 opposes the image sensor array 16 when the shading data is to be acquired, but the other surfaces of the shading roller 20 are set to oppose the image sensor array 16 when the image sensor array 16 reads the document. Hereinafter, surfaces of the shading roller 20 opposing the image sensor array 16 (in other words, the document passing through the transport path P) when the image sensor array 16 reads the document will be described.

The image reading apparatus 10 according to the embodiment is capable of performing one-side scanning for reading only one side of the document and duplex scanning for reading both sides of the document. In the embodiment, image data is formed by the CIS 18b in the case of one-side scanning.

In the case of one-side scanning, the read data acquisition unit 50 causes the first flat surface 36 to oppose the document in the shading roller 20a, and also causes the first flat surface 36 to oppose the document in the shading roller 20b when reading the document. In the case of duplex scanning, the read data acquisition unit 50 causes the first flat surface 36 or the second flat surface 38 to oppose the document in the shading roller 20a, and causes the second flat surface 38 to oppose the document in the shading roller 20b when reading the document.

The shading data may be acquired immediately before the scanning process of the document. When the acquisition of the shading data is completed, the shading roller 20 is in a state where the first white reference arc surface 30 opposes the image sensor array 16. From this state, the read data acquisition unit 50 rotates the shading roller 20 such that a predetermined surface of the shading roller 20 opposes the image sensor array 16, and then, the scanning process of the document is started. Here, on the outer peripheral surface of the shading roller 20, the first flat surface 36 is located at a position adjacent to the first white reference arc surface 30. Therefore, the amount of rotation of the shading roller 20 can be reduced by setting a surface opposing the document (in other words, the image sensor array 16) to the first flat surface 36 when the document is to be read. That is, it is possible to shorten a time from the acquisition of the shading data to the start of the scanning process of the document.

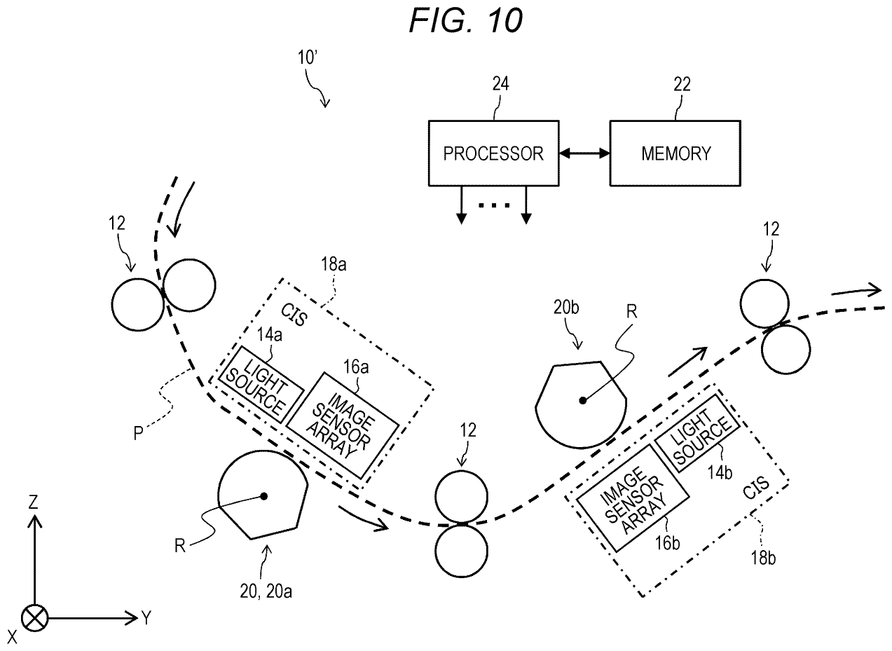

FIG. 10 is a schematic diagram illustrating a configuration of an image reading apparatus 10′ according to a modified embodiment. Constituent elements of the image reading apparatus 10′ are similar to those of the image reading apparatus 10 illustrated in FIG. 1. Also in the image reading apparatus 10′, a document is transported substantially from the left side to the right side along the transport path P.

In the image reading apparatus 10′, the transport path P is inclined with respect to a horizontal plane (XY plane), and accordingly, an opposing surface of the CIS 18 opposing the transport path P is also inclined with respect to the horizontal plane. In particular, in the image reading apparatus 10′, the opposing surface, which opposes the transport P, of the CIS 18b including the image sensor array 16b as the subsequent image sensor array is inclined with respect to the horizontal plane so as to face the upstream side and the upper side of the transport path P.

Since the opposing surface of the CIS 18b is inclined so as to face the upstream side and the upper side of the transport path P, a leading end in a transport direction of the document transported along the transport path P can abut on the opposing surface of the CIS 18b. Thus, even if foreign matter such as paper dust adheres to the opposing surface of the CIS 18b, the foreign matter can be scraped off by the document.

Although the embodiments according to the present invention have been described above, the present invention is not limited to the above-described embodiments, and various modifications can be made without departing from the gist of the present invention.

In the above-described embodiments, the processor refers to a processing device in a broad sense, and includes at least one of a general-purpose processing device (for example, a central processing unit (CPU)) or a dedicated processing device (for example, a graphics processing unit (GPU), an application specific integrated circuit (ASIC), a field programmable gate array (FPGA), a programmable logic device, or the like). The processor may be configured by cooperation of a plurality of processing devices existing at physically separated positions, instead of being configured using one processing device.

### (Supplementary Notes)

(((1)))

An image reading apparatus comprising:
a shading roller that has a columnar shape extending in a longitudinal direction and is rotatable about a rotation axis extending in the longitudinal direction, the shading roller including, on an outer peripheral surface, a first white reference arc surface which is white, has an arc-shaped cross section in a lateral direction, and extends in the longitudinal direction, and a groove portion which is located at a position preceding the first white reference arc surface in a rotation direction of the shading roller and extends in the longitudinal direction;
an image sensor array that is provided above the shading roller to oppose the shading roller across a transport path of a document, and includes a plurality of image sensors arranged in a main scanning direction and receiving reflected light of light emitted from a light source toward the document or the shading roller; and
a processor,
wherein the processor
acquires shading data based on first arc surface read data indicating pixel values output from the image sensors, respectively, and obtained as the image sensor array receives the reflected light from the first white reference arc surface,
corrects document read data, obtained as the image sensor array receives the reflected light from the document, based on the shading data to acquire corrected document read data, and
forms image data corresponding to the document based on the corrected document read data.

(((2)))

The image reading apparatus according to (((1))), wherein
the shading roller further includes, on the outer peripheral surface, a second white reference arc surface which is located at a position preceding the groove portion in the rotation direction of the shading roller, is white, has an arc-shaped cross section in the lateral direction, and extends in the longitudinal direction, and
the processor
analyzes one side arc surface read data indicating a pixel value output from each of the image sensors and obtained as the image sensor array receives the reflected light from one of the first white reference arc surface and the second white reference arc surface to identify an abnormal pixel value, affected by foreign matter existing between the one of the first white reference arc surface and the second white reference arc surface and the image sensor array when the one side arc surface read data is acquired, and replaces the identified abnormal pixel value with a pixel value of the image sensor corresponding to the abnormal pixel value to acquire the shading data, the pixel value being included in another side arc surface read data indicating pixel values output from the image sensors, respectively, and obtained as the image sensor array receives the reflected light from another of the first white reference arc surface and the second white reference arc surface.

(((3)))

The image reading apparatus according to (((2))), wherein
the processor
analyzes second arc surface read data indicating a pixel value output from each of the image sensors and obtained as the image sensor array receives the reflected light from the second white reference arc surface to identify an abnormal pixel value, affected by foreign matter existing between the second white reference arc surface and the image sensor array when the second arc surface read data is acquired, and
replaces the identified abnormal pixel value with a pixel value of the image sensor corresponding to the abnormal pixel value to acquire the shading data, the pixel value being included in the first arc surface read data.

(((4)))

The image reading apparatus according to any one of (((1))) to (((3))), further comprising:
a subsequent shading roller that is provided on a downstream side of the shading roller in the transport path and has a columnar shape extending in the longitudinal direction;
a subsequent image sensor array that is provided on a downstream side of the image sensor array in the transport path, opposes the subsequent shading roller across the transport path, is provided below the subsequent shading roller, and includes a plurality of image sensors arranged in the main scanning direction and receiving reflected light of light emitted from a light source toward the document or the subsequent shading roller; and
a contact image sensor (CIS) including the image sensor array and the subsequent image sensor array,
wherein the CIS has an opposing surface which opposes the transport path and is inclined with respect to a horizontal plane to face an upstream side and an upper side of the transport path.

What is claimed is:

1. An image reading apparatus comprising:
a shading roller that has a columnar shape extending in a longitudinal direction and is rotatable about a rotation axis extending in the longitudinal direction, the shading roller including, on an outer peripheral surface, a first white reference arc surface which is white, has an arc-shaped cross section in a lateral direction, and extends in the longitudinal direction, and a groove portion which is located at a position preceding the first white reference arc surface in a rotation direction of the shading roller and extends in the longitudinal direction;
an image sensor array that is provided above the shading roller to oppose the shading roller across a transport path of a document, and includes a plurality of image sensors arranged in a main scanning direction and receiving reflected light of light emitted from a light source toward the document or the shading roller; and
a processor,
wherein the processor
acquires shading data based on first arc surface read data indicating pixel values output from the image sensors, respectively, and obtained as the image sensor array receives the reflected light from the first white reference arc surface,
corrects document read data, obtained as the image sensor array receives the reflected light from the document, based on the shading data to acquire corrected document read data, and
forms image data corresponding to the document based on the corrected document read data.

2. The image reading apparatus according to claim 1, wherein
the shading roller further includes, on the outer peripheral surface, a second white reference arc surface which is located at a position preceding the groove portion in the rotation direction of the shading roller, is white, has an arc-shaped cross section in the lateral direction, and extends in the longitudinal direction, and
the processor
analyzes one side arc surface read data indicating a pixel value output from each of the image sensors and obtained as the image sensor array receives the reflected light from one of the first white reference arc surface and the second white reference arc surface to identify an abnormal pixel value, affected by foreign matter existing between the one of the first white reference arc surface and the second white reference arc surface and the image sensor array when the one side arc surface read data is acquired, and
replaces the identified abnormal pixel value with a pixel value of the image sensor corresponding to the abnormal pixel value to acquire the shading data, the pixel value being included in another side arc surface read data indicating pixel values output from the image sensors, respectively, and obtained as the image sensor array receives the reflected light from another of the first white reference arc surface and the second white reference arc surface.

3. The image reading apparatus according to claim 2, wherein
the processor
analyzes second arc surface read data indicating a pixel value output from each of the image sensors and obtained as the image sensor array receives the reflected light from the second white reference arc surface to identify an abnormal pixel value, affected by foreign matter existing between the second white reference arc surface and the image sensor array when the second arc surface read data is acquired, and
replaces the identified abnormal pixel value with a pixel value of the image sensor corresponding to the abnormal pixel value to acquire the shading data, the pixel value being included in the first arc surface read data.

4. The image reading apparatus according to claim 1, further comprising:
a subsequent shading roller that is provided on a downstream side of the shading roller in the transport path and has a columnar shape extending in the longitudinal direction;
a subsequent image sensor array that is provided on a downstream side of the image sensor array in the transport path, opposes the subsequent shading roller across the transport path, is provided below the subsequent shading roller, and includes a plurality of image sensors arranged in the main scanning direction and receiving reflected light of light emitted from a light source toward the document or the subsequent shading roller; and
a contact image sensor (CIS) including the image sensor array and the subsequent image sensor array,
wherein the CIS has an opposing surface which opposes the transport path and is inclined with respect to a horizontal plane to face an upstream side and an upper side of the transport path.

5. The image reading apparatus according to claim 2, further comprising:
a subsequent shading roller that is provided on a downstream side of the shading roller in the transport path and has a columnar shape extending in the longitudinal direction;
a subsequent image sensor array that is provided on a downstream side of the image sensor array in the transport path, opposes the subsequent shading roller across the transport path, is provided below the subsequent shading roller, and includes a plurality of image sensors arranged in the main scanning direction and receiving reflected light of light emitted from a light source toward the document or the subsequent shading roller; and
a contact image sensor (CIS) including the image sensor array and the subsequent image sensor array,
wherein the CIS has an opposing surface which opposes the transport path and is inclined with respect to a horizontal plane to face an upstream side and an upper side of the transport path.

6. The image reading apparatus according to claim 3, further comprising:
a subsequent shading roller that is provided on a downstream side of the shading roller in the transport path and has a columnar shape extending in the longitudinal direction;
a subsequent image sensor array that is provided on a downstream side of the image sensor array in the transport path, opposes the subsequent shading roller across the transport path, is provided below the subsequent shading roller, and includes a plurality of image sensors arranged in the main scanning direction and receiving reflected light of light emitted from a light source toward the document or the subsequent shading roller; and
a contact image sensor (CIS) including the image sensor array and the subsequent image sensor array,
wherein the CIS has an opposing surface which opposes the transport path and is inclined with respect to a horizontal plane to face an upstream side and an upper side of the transport path.
